(19) United States
(12) Patent Application Publication
(10) Pub. No.: US 2007/0062081 A1
(43) Pub. Date: Mar. 22, 2007

(54) Motion frame for pictures

(75) Inventor: Tony Chuang, Taipei Hsien (TW)

Correspondence Address: BRUCE H. TROXELL, SUITE 1404, 5205 LEESBRUG PIKE, FALLS CHURCH, VA, 22041, US

(73) Assignee: Trusty Industrial Inc.

(21) Appl. No.: 11/230,582

(22) Filed: Sep. 21, 2005

(51) Int. Cl. G09F 19/00

(52) U.S. Cl. 40/430

(57) ABSTRACT

A motion frame for pictures comprising a frame with which a grating plate and pictures are tightly compressed together, and a frame stand having thereon a motor of which the level can be adjusted; the frame is assembled on the frame stand, a specific shaped leaf driven by the motor can fast change the inclined angular position of the frame, and an effect that pictures are automatically changed and entirely presented in long durations can be achieved.

### BACKGROUND OF THE INVENTION

1. Field of the invention

The present invention is related to an improved motion frame for pictures, and especially to an improved motion frame for pictures with which the pictures can fast move and automatically change, and the pictures can be entirely presented for long durations.

2. Description of the Prior Art

Products each with the effect of mutual changing of two or more than two pictures according to the principle of refraction of cylindrical mirror grating are more and more popularized; each product with two changing pictures originally has a grating plate clung on the pictures and moved by a viewer to a different angular viewing position, and then he can see the changing of the two pictures.

In order to meet the requirement of advertisement to elevate the visual effect and to attract people's eye sights, there have been various automatically picture changing frames developed. Although the mechanisms of them are more or less different, they all observe a principle, that is, in each case, the grating plate is separated from the pictures, a motor is provided to drive either of the grating plate and the pictures, so that a viewer stay at a position unmoved can see nonstop changing of the two pictures.

The structure has two defects: one is that the grating plate and the pictures must be kept a very suitable tightness or looseness; if they are too tight, an overly large impedance may exist; while if they are too loose, the changing effect of the pictures will be inferior, the larger the sizes are, the harder they will be controlled. The other is that the motor is rotated with a fixed rotational speed, when an eccentrically rotating round member with an axle as a rotating center drives the pictures to make changing, the durations for entirely presenting the pictures before they get into the processes of alternately changing are short, the important effect for customers to clearly see the contents of the advertisements is unable to get.

FIGS. 1A to 1E are schematic views showing the operations of a conventional motion frame for two pictures, wherein a round pushing leaf 503 being eccentric to a rotating axle 504 of a motor is placed at an opening of a moving article 501, the moving article 501 can be connected with a grating plate or the pictures for angular changing.

In the drawings of FIGS. 1A to 1E, 502 indicating a horizontal line at the center of the rotating axle 504 of the motor, in the drawings the states of moving of the moving article 501 by rotating clockwise of the rotating axle 504 of the motor every 90 degrees are shown. We can see that the article 501 is all the way moved gradually following the rotating of the rotating axle 504; i.e., the grating plate or the pictures change their angular presenting positions gradually to make the pictures change. By virtue that such a conventional structure takes advantage of the rotating eccentric pushing leaf 503 to render the two different pictures always to keep the processes of slowly alternately changing, so that the durations for entirely presenting the pictures are short, the effect for presenting the entire pictures in predetermined durations can not be achieved.

### SUMMARY OF THE INVENTION

In order to get rid of the above two main defects of the conventional structures, the present invention tightly compresses together a grating plate and pictures with a frame, then the frame is placed on a frame stand, the frame thus can be varied between two set inclined angular positions, and an effect that the two pictures are automatically changed and entirely presented in long durations can be achieved.

The main improvement of the present invention is to provide a leaf with a specific shape and being driven by a motor, the leaf with a specific shape is used to achieve the effect that the two pictures are automatically changed and entirely presented in long durations; and the leaf can be made of plastic or metal etc. The specific shaped leaf includes two or more than two semicircles of different radii or two non circular shapes in order to shorten the durations for changing their angular presenting positions, thus the durations for entirely presenting the pictures are lengthened.

Another improvement of the present invention is to provide a device on the motor to adjust the level of the motor, thus the initial angular position of the frame can be adjusted to allow the first one of the pictures to be entirely presented.

The present invention will be apparent after reading the detailed description of the preferred embodiment thereof in reference to the accompanying drawings.

### BRIEF DESCRIPTION OF THE DRAWINGS

FIGS. 1A to 1E are schematic views showing the operations of a leaf of a conventional motion frame;

FIG. 2 is a top view of a stand of a motion frame for pictures of the present invention;

FIG. 3 is a sectional front view of the stand of the motion frame for pictures of the present invention;

FIG. 4 is a side view showing the frame stand of the present invention is combined with the motion frame for pictures having thereon a grating plate;

FIG. 5 is a plan view showing a specific shaped leaf of the motion frame for pictures of the present invention;

FIGS. 6A to 6E are schematic views showing the operations of changing pictures of the leaf of FIG. 5;

FIG. 7 is a plan view showing another specific shaped leaf of the motion frame for pictures of the present invention;

FIG. 8 is a plan view showing a further specific shaped leaf of the motion frame for pictures of the present invention, the motion frame can be applied to three pictures;

FIGS. 9 and 10 are sectional side views of the motion frame for pictures of the present invention showing a device on a motor is used to adjust the level of the motor.

### DETAILED DESCRIPTION OF THE PREFERRED EMBODIMENT

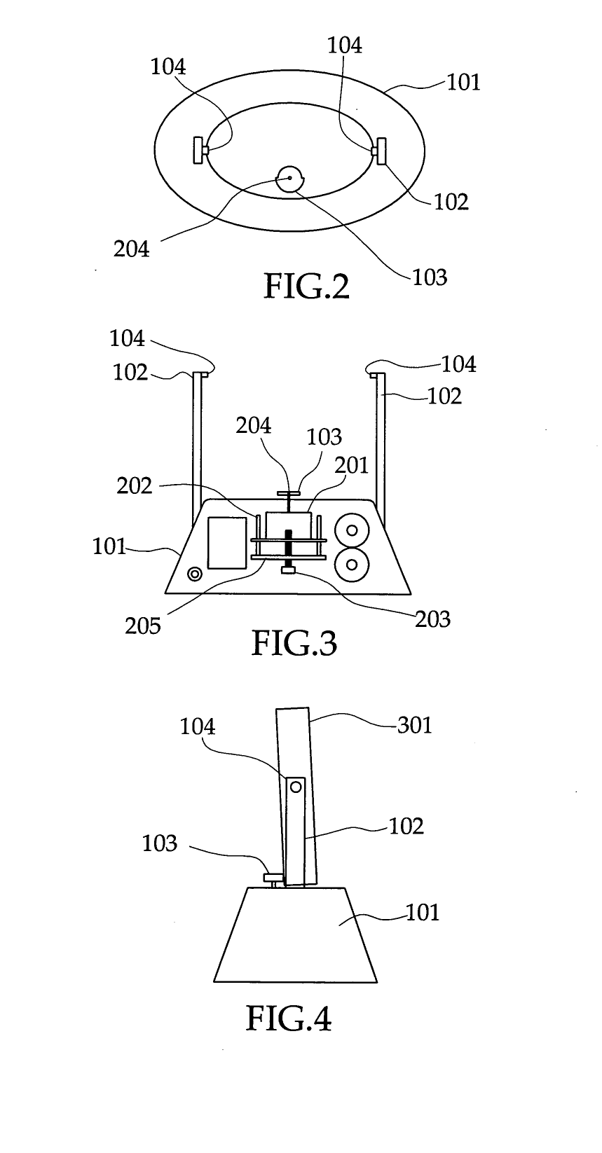

Referring to FIGS. 2 and 3, the present invention has a frame stand composed of a base 101 and a frame bracket device 102, protruding axles 104 are provided on two mutually opposite sides respectively on the frame bracket device 102. There is a set of electric power supplying equipment including batteries, a transformer, an electric power socket and a switch etc. (not shown) provided in the base 101; excepting these, a motor 201 has a rotating axle 204 protruding upwardly out of the horizontal surface of the base 101, the rotating axle 204 has on its top end a specific shaped leaf 103. The main body of the motor 201 is placed on a cylinder 202 of the base 101, a movable screw 203 in the base 101 is used to control the desired level of the motor 201; the movable screw 203 is extended through a fixed plane 205 at the bottom of the cylinder 202 to be locked onto the bottom surface of the motor 201. By rotation of the screw 203, the horizontal levels of the motor 201 and the leaf 103 can be adjusted, thus a device for adjusting the level of the motor 201 can thus be formed. Wherein the specific shaped leaf 103 is composed of two or more than two semicircles or non semicircles of different radii, the rotating axle 204 of the motor 201 is extended through the rotating center of the specific shaped leaf 103, and the specific shaped leaf 103 will be specifically described about its nature.

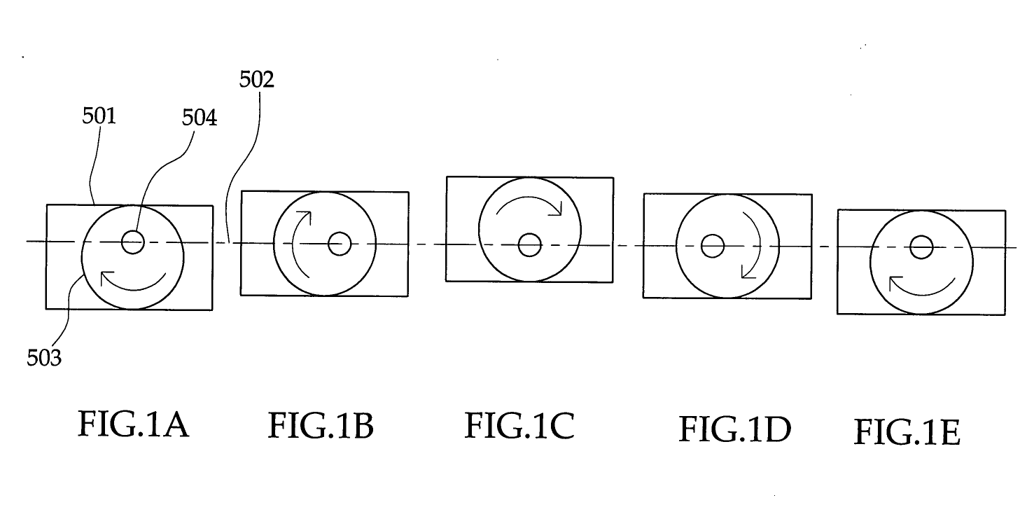

The frame stand of the present invention is different from a conventional frame structure in two points, one is that the end of a motor of the conventional frame for changing pictures has an eccentrically rotating round pushing leaf fixed on an axle at a rotating center thereof (referring to 503 in FIG. 1A), by rotating of the pushing leaf about the eccentrically rotating center to move pictures to and fro; the other one is that the motor of the conventional frame for changing pictures is fixed on a base of the frame, there is no designing for adjustment of moving.

Further please refer to FIG. 4, the frame stand of the present invention is mounted thereon with a frame 301; the frame 301 is provided therein with a grating plate and the pictures tightly compressed and combined together, the pictures can be more than two by amount. The frame 301 is pivotally connected on protruding axles 104 provided on the frame bracket device 102 on two lateral sides thereof; the bottom of the frame 301 is kept a distance from the horizontal upper surface of the base 101 of the frame stand, so that the frame 301 can be adjusted angularly about a central line formed by the two protruding axles 104. By supporting of the frame bracket device 102, the frame 301 pends downwards and leans in a declined way on an edge of the specific shaped leaf 103, the specific shaped leaf 103 is rotated by the motor 201 to push the bottom portion of the motor 201 and meantime change the declined angle of the frame 301.

The features of the shaped leaf 103 and the designing for adjustment of moving of the motor 201 of the present invention will be specified below:

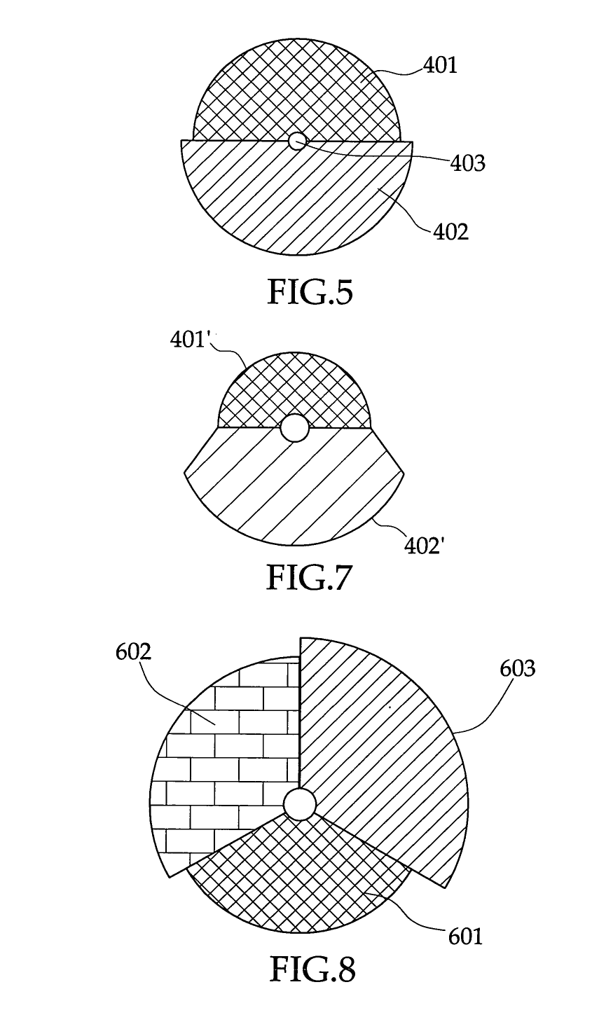

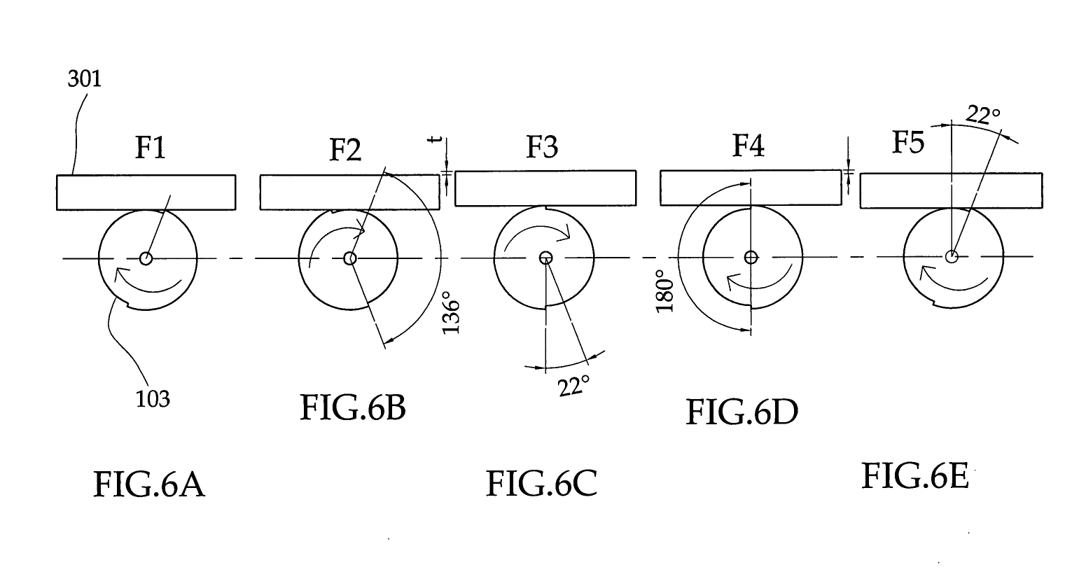

Referring to FIG. 5 which shows an embodiment of specific shaped leaf 103 designed for two pictures, the specific shaped leaf 103 is composed of two semicircles 401, 402 of which one has a smaller radius while the other has a larger radius; but the two semicircles 401, 402 are concentric, and take a concentric circle 403 as their center for assembling with the rotating axle 204 of the motor 201. This specific designing can render two different pictures in a grating plate of the frame 301 to change with each other in a shortest time; however the durations for entirely presenting the two different pictures are lengthened. Referring to FIGS. 6A to 6E which are schematic views showing the operations of rotating of the frame 301 by the shaped leaf 103, as compared with the conventional technique shown in FIGS. 1A to 1E, the specifically shaped leaf 103 of the present invention can push the frame 301 having the grating.

FIG. 6A shows the state that the frame 301 having the grating of the present invention leans in a declined way on the specific shaped leaf 103 when the motor 201 has not yet been activated, while the state when the smallest round arc of the leaf 103 contacts the frame indicates the initial position; this angular position of the frame is assumed to be exactly an angular position that the first picture on the grating plate is entirely presented; FIG. 6B shows the state that the frame 301 is still unmoved when the motor 201 rotates clockwise, this indicates that the first picture on the grating plate all the way is entirely presented during this stage of time; FIG. 6C shows the state that the motor 201 rotates for 22 degrees, we can see the frame 301 having the grating is pushed upwards a small distance “t” by the specific shaped leaf 103 in this short duration, and this distance “t” is exactly the difference between the radii of the two semicircles 401 and 402 (referring to FIG. 5), it is assumed that the angular change exactly allows the second picture on the grating plate is entirely presented; FIG. 6D shows the state that the motor 201 rotates again for 180 degrees, the frame 301 having the grating is kept unmoved all the way, this indicates that the second picture on the grating plate all the way is entirely presented; FIG. 6E shows the state that the motor 201 rotates again for 22 degrees to get back to the original position, in this short duration, the second picture on the grating plate again is changed for the first picture, and the frame 301 having the grating abuts against the specific shaped leaf 103 to render the latter to move down for a small distance “t”.

By comparing the FIGS. 1 and 6, we can see how the present invention and the conventional technical structure are different in effects they result.

The difference of radii of the two semicircles 401 and 402 of the specific shaped leaf 103 is related to the angular change of the frame 301 having the grating, the problem of changing angles of the frame 301 to change the first picture for the second picture can thus be solved; to enlarge or reduce the peripheral lengths of the two semicircles 401 and 402 non equivalently proportionally can change the durations of entirely presenting the two pictures on the frame 301 having the grating.

The specific shaped leaf 103 is not limited to two by amount; the specific shaped leaf 103 is composed of two or more than two semicircles or non semicircles.

If it is desired to have the two different pictures in the frame 301 having the grating obtained equal durations for entirely presenting, referring to FIG. 7, the specific shaped leaf 103 is composed of a semicircle 401′ and a non semicircle 402′ of which one has a smaller radius while the other has a larger radius; wherein the length of the round arc of the non semicircle 402′ is designed to be equal to the length of the round arc of the semicircle 401′, in this way, the two different pictures in the frame 301 having the grating can have equal durations for presenting.

If the frame 301 having the grating has therein three different pictures, if it is desired to make the three different pictures in the frame 301 having the grating have equal durations for entirely presenting, referring to FIG. 8, the specific shaped leaf 103 is composed of three non semicircles of different radii, the three non semicircles are sectors 601, 602 and 603 which are concentric, but the peripheral lengths of the three sectors 601, 602 and 603 are equal, in this way, the three different pictures can have equal durations for entirely presenting.

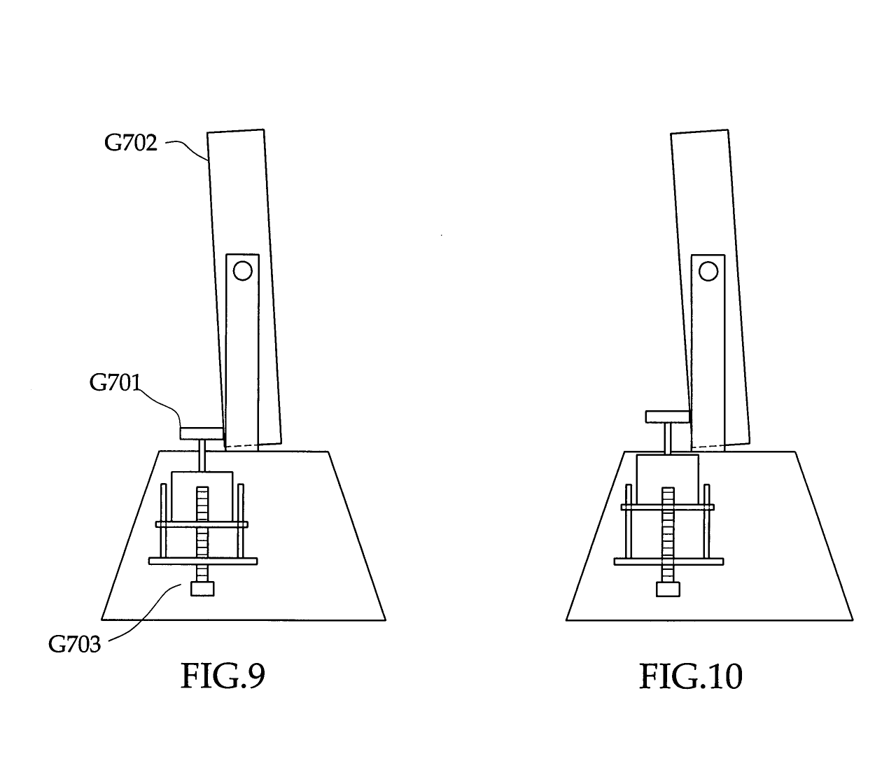

Addition to these, a design for adjustment of moving of the position of the motor 201 is: the design is for solving the problem of non equivalency of the refraction angles of different grating plates, referring to FIG. 9, a frame 702 having a grating is placed on a frame stand, the bottom of the frame 702 leans in a declined way on an edge of a specific shaped leaf 701, if a first picture or a second picture is in an angular position to render the two pictures alternate with each other, a movable screw 703 shall be adjusted for raising or lowering the level of the motor 201; when the motor 201 is raised by adjustment, the specific shaped leaf 701 will push the frame 702 having the grating rightwards to change the angular position of the grating, such as is shown in FIG. 10, the picture presented by the grating now naturally changes, it needs only to adjust to render one of the pictures to be entirely presented, this operation exactly makes the assumed situation shown in FIG. 6A.

The specific shaped leaf 103 (701) mounted on the rotating axle 204 of the motor 201 can be of a fixed type or can be a changeable device.

Naturally, other linking-up mechanism can be provided between the specific shaped leaf 103 (701) and the frame 301 (702) to hide the rotating leaf 103 (701); alternatively, the grating plate in the frame 301 (702) can be angularly changed; both these are simple alteration of the present invention.

In conclusion, novel structure of the motion frame for pictures provided by the present invention surely can get the effect of making the duration of entirely presenting the pictures elongated; the present invention therefore has improvement, what we claim as new and desire to be secured by Letters Patent of the United States is:

1. A motion frame for pictures comprising:
a frame stand composed of a base and a frame bracket device, said base at least is mounted therein with a motor and a set of power supplying equipment, a rotating axle of said motor is connected with a leaf, said leaf is composed of two or more than two concentric semicircles or non semicircles of different radii; and
a frame with a grating, said frame has therein a grating plate and at least two pictures, and is mounted on said frame bracket device and is adapted to changing its angular position by rotating said leaf, so that said pictures are adapted to entirely presenting for a longer duration.

2. A motion frame for pictures as claimed in claim 1, wherein exposed peripheral lengths of said two or more semicircles or non semicircles of said leaf are adapted to being enlarged or reduced equivalently proportionally and non equivalently proportionally.

3. A motion frame for pictures as claimed in claim 1, wherein said leaf is made of plastic or metal.

4. A motion frame for pictures as claimed in claim 1, wherein said leaf on said rotating axle of said motor is of a fixed type or is a changeable type.

5. A motion frame for pictures as claimed in claim 1, wherein said motor mounted in said base is provided with a device to adjust level of said motor, thus an initial position of said frame allows said first one of said pictures to be entirely presented.

6. A motion frame for pictures as claimed in claim 5, wherein said device to adjust level of said motor places a main body of said motor on a cylinder in said base, a movable screw in said base is extended through a fixed plane at a bottom of said cylinder to be locked onto a bottom surface of said motor, by rotation of said screw, levels of said motor and said leaf are adjusted.

7. A motion frame for pictures as claimed in claim 1, wherein said set of electric power supplying equipment includes a power source, a transformer, an electric power socket and a switch.

8. A motion frame for pictures as claimed in claim 1, wherein said peripheral lengths of said two concentric semicircles or non semicircles of different radii are equal, thereby duration for entirely presenting each of said pictures is equal.
